(19) United States
(12) Patent Application Publication
(10) Pub. No.: US 2011/0064926 A1
(43) Pub. Date: Mar. 17, 2011

(54) COMBINED BOARDS WITHOUT CORRUGATED MEDIUM HAVING ENHANCED SURFACE PROPERTIES

(75) Inventors: Vladislav A. Babinsky, Fuquay Varina, NC (US); Bruce W. Babcock, Charleston, SC (US)

(73) Assignee: MEADWESTVACO CORPORATION, Richmond, VA (US)

(21) Appl. No.: 12/991,790

(22) PCT Filed: May 14, 2009
(86) PCT No.: PCT/US2009/043891

§ 371 Date: Nov. 9, 2010

Related U.S. Application Data
(60) Provisional application No. 61/053,245, filed on May 15, 2008.

(51) Int. Cl. B32B 7/14; B32B 37/12; B32B 29/00

(52) U.S. Cl. 428/201; 156/60; 428/537.5

(57) ABSTRACT

A low-cost combined board without corrugated medium is disclosed that has enhanced surface properties and bending stiffness. In certain embodiments the combined board has a surface suitable for high quality printing and without the characteristic lines that are apparent on the surface of the conventional corrugated board. The combined board includes at least two paperboards adhered together by an adhesive formulation. The adhesive formulation may comprise one or more of an adhesive component, a foaming component, and filler. The adhesive may be a pattern of adhesive comprising strands of adhesive with a diameter range of about 2 points to about 20 points. When desired, the adhesive formulation may include a spacer component to control the distance between the paper board layers in the disclosed combined board. The adhesive may include hard fillers to further enhance the bending stiffness and reduce the adhesive cost.

### REFERENCE TO RELATED APPLICATIONS

This application claims the benefit of priority under 35 U.S.C. §119(e) of provisional applications Ser. No. 61/053,245 filed on May 15, 2008, and Ser. No. 61/089,582 filed on Aug. 18, 2008, which are hereby incorporated by reference in their entireties.

### BACKGROUND OF THE DISCLOSURE

Miniflute combined board is commonly used for packaging of high quality goods where good surface for printing is required. One drawback of this combined board is that lines corresponding with the folds of medium are visible on its surface. As a result, a lamination of the combined board surface with white paper is typically required to provide the board with high printing quality without undesirable lines. This increases the production cost significantly. Bleached or unbleached board having high caliper may be used for packaging of high quality goods; however, the high caliper board is rather expensive.

Accordingly, there is a need for combined boards that are low cost, yet provide excellent or enhanced print surface suitable for packaging of high quality goods. It is also desirable to have combined boards that provide enhanced binding stiffness.

### SUMMARY OF THE DISCLOSURE

A low-cost combined board is disclosed having a surface suitable for high quality printing and without the characteristic lines that are apparent on the surface of the conventional corrugated board. The combined board includes a layer of adhesive formulation and at least two liner boards adhered together by the adhesive. The adhesive formulation comprises an adhesive component, a foaming component, and filler. When desired, the adhesive formulation may include a spacer component to control the distance between the liner board layers in the disclosed combined board.

Also disclosed is a low-cost combined board without corrugated medium that has enhanced surface properties and bending stiffness. The disclosed combined board includes at least two liner boards adhered together by a pattern of adhesive comprising strands of adhesive with a diameter range of about 2 points to about 20 points. The adhesive strand may include hard fillers to further enhance the bending stiffness and reduce the adhesive cost.

### DETAILED DESCRIPTION

The combined board now will be described more fully hereinafter, but not all embodiments are necessarily shown. Indeed, the combined board may be embodied in many different forms and should not be construed as limited to the embodiments set forth herein; rather, these embodiments are provided so that this disclosure will satisfy applicable legal requirements.

While the combined board is described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof.

In one embodiment, the combined board of the present disclosure includes:
(a) a layer of adhesive formulation, comprising an adhesive component, a foaming component, and a filler; and
(b) at least two liner boards adhered together by the adhesive.

Several known natural and synthetic adhesive compounds may be used as an adhesive component. These include, but are not limited to, starch, ethyl-vinyl acetate polymer (EVA), polyvinyl acetate (PVAc), and polyvinyl alcohol (PVOH).

The foaming component may comprise a latex emulsion and, optionally, a foam stabilizer. Suitable latex emulsions for use in the foaming component of the disclosed adhesive formulation may include, but are not limited to, styrene-butadiene emulsion, acrylic-styrene-butadiene emulsion, and combinations thereof. Cellulosic-based foam stabilizer such as Aerowhip® commercially available from Hercules, Inc. may be used as a foam stabilizer. The foaming component may include a mechanically-induced foam achieved by stirring. Mechanically whipped latex may be used as foam.

The filler may be included in the disclosed adhesive formulation to impart additional rigidity/stiffness performance or to reduce the formulation cost. The filler may be mineral or fibers. Suitable fillers for use in the present disclosure may include, but are not limited to, pearl starch, calcium carbonate, sawdust, gypsum, plaster, clay, corn seed skin, gluten feed, cellulosic insulation such as that is available from Cell-Pak LLC or Nu-Wool Company, Inc., wood flour, saw dust, cellulose pulp, rayon fiber, and synthetic fibers. Cellulose insulation is a low cost product made from recycled newspapers.

Gas emitting chemicals, such as baking soda, may be added to the starch filler for foaming and gas bubble creation. For example, sodium bicarbonate (baking soda) and an acid in the form of salt crystals are dry-mixed with the starch filler, generating a mixture. The acid salt crystal may be a high-temperature acid salt for foaming such as aluminum salt, and calcium aluminum phosphate. Upon dissolving the mixture in water, the acid and sodium bicarbonate react and emit carbon dioxide gas, which expands and foams the mixture.

Several materials may be incorporated into the adhesive formulation for a spacer function in order to keep liner boards in the combined board at a certain distance. These may include, but are not limited to, wood particles; sawdust; cellulose fibers; natural fibers such as cotton, hemp, jute, flax, ramie, and linen; and byproducts of corn manufacturing process such as seeds skin, gluten feed, germ, and hulls. When byproduct of corn manufacturing is incorporated into the disclosed adhesive formulation, enhanced strength performance may be achieved. The amount of byproduct of corn manufacturing in the adhesive formulation may be in a range of 2-50% by weight. The byproduct of corn manufacturing may be refined in the papermaking refining or in grinding devices with ceramic grinding plates to the particle size in the range of 50-500 microns.

The adhesive formulation may comprise a surfactant capable of producing a stable foam. The surfactant may create a foam with a void volume in a range of about 15% to about 60%. In one embodiment, the surfactant may create a form with a void volume greater than 25%. Void volume is defined as the weight fraction of adhesive displaced by the air in the foam. For example, a void volume of 40% means that 40 grams out of every one hundred grams of adhesive has been replaced with air.

When desired, the disclosed adhesive formulation may further comprise ???These are non-functional??? additives that may include, but are not limited to, preservatives; defoamers; wetting agents; plasticizers; solubilizing agents; rheology modifiers; water conditioners; penetration control agents; peptizers such as urea; gelatinization temperature modifiers; inert fillers such as clay and finely ground polymers; thickeners such as inorganic colloidal clays, guar, hydroxyethyl cellulose, alginates, polyvinyl alcohol, polymers of ethylene oxide and the like; colorants; and emulsions such as polyvinyl acetate. These additives may be present in a small amount.

In one embodiment, the adhesive formulation may comprise an adhesive, a latex emulsion such as styrene-butadiene or acrylic SRB latex, Aerowhip® foam stabilizer, wood flour, corn fibers, calcium carbonate, and starch.

To further reduce the production cost of the disclosed packaging board, the adhesive component may be prepared using the known “Stein-Hall” process. Adhesives used in conjunction with the Stein-Hall process are traditionally alkaline adhesives consisting of ungelatinized starch suspended in an aqueous dispersion of gelatinized starch. The ungelatinized starch facilitates the absorbtion of water during drying process and the fast formation of green bond between liner boards. The adhesive is produced by gelatinizing starch in water with sodium hydroxide to yield a primary mix of gelatinized starch carrier, and then slowly adding the resulting primary mix to a secondary mix of ungelatinized starch, borax and water. The primary mix of gelatinized starch carrier was prepared by cooking 72.0 g of corn starch in 600.5 g of water at 45° C., adding an aqueous solution of 10.8 g sodium hydroxide in 33.4 g of water, and then agitating the resulting mixture for 5 minutes. The secondary mix was prepared by mixing 967.4 g water, 9.6 g borax (pentahydrate), and 520.0 g corn starch at about 35° C. The obtained secondary mix was added to the primary mix carrier under agitation.

In addition to imparting high viscosity and fast formation of green bond, the adhesive component prepared by the Stein Hall process may function as a spacer to keep liner boards in the disclosed packaging board separated at a certain distance. Upon drying of the assemblied packaging board, ungelatized starch hydrates and subsequently imparts an additional strength and stiffness to the finished board.

A stable colloidal dispersion may be prepared by subjecting a granular water-insoluble hydrophobic starch derivative having a degree of substitution of 0.1 to 1.0 and a moisture content of about 4% to 30% to mechanical shear and compression at super atmospheric pressure and 100° C. to 250° C., forcing the mass through a restrictive opening with a sudden release of the pressure to expand the mass to a porous composition of fragmented granules, and finally comminuting the porous foamed composition.

In one embodiment, the packaging board may be biodegradable. The packaging board may include an expanded adhesive material comprising an expanded amylose starch product of at least 45% by weight total amylose content. The expanded adhesive has a low density, closed cell structure with good resilience and compressibility properties. The expanded adhesive material of the present disclosure may have a resiliency of at least about 50% and a compressibility in a range of about 100 g/cm² to 2,000 g/cm².

The adhesive formulation has excellent pseudoplastic performance, low shear Brookfield viscosity suitable to hold the gaps between the liners, yet high shear viscosity suitable for application process. The Brookfield viscosity may be in a range of about 2,000-50,000 cps. The shear viscosity may be in a range of about of 100-5,000 cps. In some embodiments, the viscosity may be more than 10,000 cps, so the applied adhesive may further function as a design component that holds the pressure force when the subsequent layer of liner is placed on the adhesive. In one embodiment, the viscosity of the adhesive formulation is in a range that sufficiently keeps the distance between the linerboards under pressure of the laminating nip at least about 50% of the initial volume of the adhesive together with filler.

The combined board of the present disclosure may be produced by a process comprising steps of:
(a) applying, onto a surface of a first liner board, a layer of adhesive formulation comprising an adhesive component, a foaming component, and a filler;
(b) placing a second liner board onto the layer of adhesive formulation in (a) to provide a combined board assembly;
(c) applying pressure onto the combined board assembly; and
(d) drying the board assembly in (c) to provide the combined board.

The adhesive layer may be applied to the surface of liner board by any known coating technique. These include, but are not limited to, rod coatings, blade coatings, curtain coatings, spray coatings, and extrusion. When cellulosic insulation is used as filler, the adhesive formulation may be pneumatically applied to form a blanket of interlocking fibers. Additionally, cellulose insulation may be mixed with other fillers in the adhesive formulation and applied by known coating techniques. The layer of adhesive may have a density range of about 0.1-30 lb/ft³ after drying.

When desired, the disclosed board may comprise more than one adhesive layer. After being applied to the liner surface, the first adhesive layer may be semi-dried such as to about 60-80% solids. Then, the second adhesive layer may be applied onto the surface of the first adhesive layer, followed by additional liner board(s). The assembly may then be pressed to a desired thickness.

When a spraying technique is used for coating the adhesive formulation onto the liner board surface, the adhesive formulation properties and spray conditions may be optimized such that the resulting coated surface of the liner board has a selected topography. A coated surface with hills and valleys of desired size may be achieved. The droplets of adhesive formulation may be coalesced to cover a certain surface area of the liner board, and therefore, set the distance between liner boards at certain gap. When the liner board is placed on the top of adhesive-coated liner board surface, some voids may be present between liners, and the adhesive may function as a filler to partially fill the gap between the liner boards. The adhesive may be coalesced to cover about 20-60% of the total liner board surface.

The adhesive layer may be applied as a pattern onto the surface of the liner boards using a specially designed applicator. The pattern may include strands of adhesive in a curved shape. The strands may be in a sinusoid shape or random shape relatively uniformly covering the surface of the liner board to be laminated. This pattern application of the disclosed adhesive would greatly reduce the amount of adhesive typically required in the conventional laminating process where the entire surface of board is covered by adhesive.

The adhesive formulation may be applied onto the liner board in the form of strands such as that a uniform thickness of the adhesive layer may be achieved. Furthermore, the strands can be applied such that a fiber-like coverage may be formed on the surface of liner board, providing a complete coverage but with non-uniform thickness because of crossing/touching of neighbor strands only in certain areas. The adhesive properties are selected in such that the strands of adhesive will retain their shape after laminating and will be deformed only slightly during the laminating step when the pressure is applied to bring the sheets of board together.

After being applied onto the liner board, the adhesive may be dried to a specified level to create strength that will sustain the compression force during the finished product assembly stage. Additional liner board(s) is then placed on the surface of the adhesive layer, and pressed to a desired thickness to provide a finished board assembly. In one embodiment, the liner board is pressed in a nip to a thickness of about 20-100% greater than the expected thickness of the combined liners without the adhesive. The resulting finished board is then dried. A variety of known drying means for paperboard may be used in the present disclosure. These include, but are not limited to, heated air, hot plates, infrared, and combinations thereof. A moisture content of the adhesive may be in a range of 20-30% after pressure and temperature is applied to the liner boards.

The combined board of the present disclosure has surface properties suitable for high quality printing and without the characteristic lines that are apparent on the surface of the conventional corrugated board.

Additionally, the packaging board of the present disclosure exhibits excellent scoring properties. A slot applicator was used to discharge strands of the disclosed adhesive formulation onto the liner boards. The discharge intensity may be optimized to reduce the stiffness of the packaging board in the MD and CD directions. Additionally, the distance between the strands and the thickness of the foamed adhesive on the liner boards may be adjusted to accommodate the scores in MD and/or CD directions.

TABLE 1 illustrates that the density of the medium in the corrugated combined board is greater or equal to the density of foam for the board types F, G, N, and K/S. The required weight of the packaging boards of the present disclosure may be significantly lower than that of the conventional corrugated boards, thereby reducing the production cost.

TABLE 1

| | | | | | Ratio of | | | | Volume | |
|---|---|---|---|---|---|---|---|---|---|---|
| | Min. | Max. | Min. | Max. | Medium | Liner | Medium | Medium | of | |
| Board | Height | Height | Flutes | Flute | to Liner | Caliper | BW | Caliper | Medium | Density |
| Type* | (in.) | (in.) | per ft | per ft | Length | (in.) | (lb/msf) | (pt) | in³/msf | (lb · ft³) |
| A | 0.16 | 0.22 | 30 | 37 | 1.54 | 0.01 | 33 | | 11.7 | 4.356 |
| B | 0.097 | 0.012 | 46 | 50 | 1.35 | 0.01 | 33 | | 6.42 | 6.9429 |
| C | 0.142 | 0.145 | 38 | 41 | 1.43 | 0.01 | 26 | 8 | 10.2 | 3.657 |
| D | 0.067 | | 62 | | 1.24 | 0.01 | 26 | 8 | 3.92 | 8.2315 |
| E | 0.045 | 0.062 | 61 | 95 | 1.27 | 0.01 | 26 | 8 | 2.08 | 15.85 |
| F | 0.0295 | 0.032 | 106 | 128 | 1.23 | 0.007 | 26 | 8 | 1.29 | 24.759 |
| G | 0.023 | | 146 | | 1.19 | 0.007 | 23 | 7 | 0.75 | 36.493 |
| N | 0.02 | | 170 | | 1.23 | 0.005 | 23 | 7 | 0.83 | 33.948 |
| K/S | 0.026 | 0.275 | 25 | | 1.55 | 0.007 | 23 | 7 | 1 | 35.65 |

*Foam Density = 1.5-9 lb/ft³

In another embodiment, a combined board of the present disclosure includes:
(c) a first liner board;
(d) a second liner board; and
(e) a pattern of adhesive comprising strands of adhesive having diameter range of about 2 points to about 20 points, wherein the first liner board and the second liner board are adhered together by the pattern of adhesive.

The first and second liner boards may be bleached boards, unbleached boards, or combinations thereof.

Any type of the adhesive pattern may be used. For example, the pattern of adhesive may be in a curved shape. Furthermore, the adhesive strands may be in a sinusoidal shape or a random shape relatively uniformly covering the surface of board to be laminated.

The adhesive properties may be selected in such a way that the strands of adhesive retain their shape after the lamination process of the liner boards, and that the adhesive strands may be deformed only slightly during the laminating process when a pressure is applied to bring the two liner boards together.

Several known natural and synthetic adhesive compounds may be used as an adhesive component in the present disclosure. These include, but are not limited to, starch, ethyl-vinyl acetate polymer (EVA), polyvinyl acetate (PVAc), and polyvinyl alcohol (PVOH).

When desired, the adhesive may further include a hard filler to provide additional rigidity/stiffness of the strands and/or to reduce cost. Various fillers may be used. These include, but are not limited to, cellulosic insulation such as those available from Cell-Pak LLC and Nu-Wool Company, Inc.; wood flour; saw dust; cellulose pulp; rayon fiber; synthetic fibers; and combinations thereof. The cellulose insulation is a low cost product that may be made from recycled newspapers.

The disclosed combined board may require a reduced amount of adhesive compared with the amount typically utilized in the conventional laminating process where the entire surface of the substrate is covered by adhesives without voids. Moreover, the disclosed combined board exhibits an enhanced bending stiffness compared to a single ply board.

A method of producing the combined board of the present disclosure may include the steps of:
(a) providing an adhesive comprising strands of adhesive having diameter range of about 2 points to about 20 points; and
(b) applying a pattern of the adhesive to a first liner board; and
(c) applying a second liner board onto the first liner board such that the pattern of adhesive is between the first liner board and the second liner board, to provide a board assembly.

The method of producing the combined board may further includes steps of applying pressure onto the board assembly and drying the resulting board assembly to provide the disclosed combined board.

When desired, the adhesive pattern applied onto the first liner board may be dried prior to an application of the second liner board to maintain the distance between liner boards. In one embodiment, the adhesive pattern may be partially dried to impart strength that sustains the compression applied on the second liner board to complete the assembly of the combined board.

The adhesive may be of substantial thickness and may require a considerable amount of time and energy to dry. To reduce drying energy, the adhesive may have a percent solids in a range of about be 50% to about 70%. When a further reduction in the drying energy is desired, the adhesive may be applied as more than one component or portion.

In certain embodiments, a first adhesive component having 50-70% solids may be applied onto the first liner board and then dried to the solids of 80-90%. Subsequently, a second adhesive component may be applied onto the dried first adhesive component. The second adhesive component may include a tackifier and may have solids of 30-50%. Examples of tackifier suitable for such second adhesive component may include, but are not limited to, rosin, rosin ester, acrylics, aliphatic resins, aromatic resins, and combinations thereof. The second adhesive component may be in a range of about 2% to about 10% by weight of the first adhesive component.

In certain embodiments of the present invention, the first adhesive component may be applied onto the first liner board and then dried to the solids of 60-80% solids. Subsequently, the second adhesive component may be applied onto the semi-dried first adhesive component. Then, the second liner board may be placed onto the second adhesive component and pressed to provide the disclosed combined board.

The pattern of adhesive may be applied to the first liner board by a specially designed applicator or a known applicator. When desired, the distance between the first liner board and the second liner board may be set at a selected height.

In certain embodiments, the pattern of adhesive may be sprayed-coated onto the first liner board such that the coated surface has a complex topography with hills and valleys of desired size depending on adhesive formulation properties, as well as applicators/spray conditions and factors.

In certain embodiments, the adhesive pattern applied onto the first liner board may comprise a peak/valley pattern. The second liner board may then be positioned on the peaks of the coated surface, leaving some voids between the two liner boards and the adhesive.

In certain embodiments, the adhesive strands may be coalesced to cover from about 20% to about 60% of the total surface of the first liner board.

It is to be understood that the foregoing description relates to embodiments that are exemplary and explanatory only and are not restrictive of the disclosure. Any changes and modifications may be made therein as will be apparent to those skilled in the art. Such variations are to be considered within the scope of the disclosure as defined in the following claims.

1. A combined board, comprising:
a first paperboard;
a second paperboard; and
a pattern of strands comprising an adhesive formulation, the strands having a diameter range from about 2 points to about 20 points, the adhesive formulation comprising an adhesive component and optionally comprising at least one of a foaming component and a filler;
wherein the first paperboard and the second paperboard are adhered together by the pattern of strands, and
wherein no corrugated medium is between the first and second paperboards.

2. A combined board, comprising:
a first paperboard;
a second paperboard;
a layer of adhesive formulation, comprising an adhesive component, a foaming component, and a filler;
wherein the first paperboard and the second paperboard are adhered together by the adhesive formulation, and
wherein no corrugated medium is between the first and second paperboards.

3. The board of claim 1, wherein the adhesive component comprises a material selected from the group consisting of starch, ethyl-vinyl acetate polymer, polyvinyl acetate, polyvinyl alcohol, and combinations thereof.

4. The board of claim 1, wherein the filler comprises a material selected from the group consisting of pearl starch, calcium carbonate, sawdust, gypsum, plaster, clay, corn seed skin, gluten feed, cellulosic insulation, wood flour, saw dust, cellulose pulp, rayon fiber, synthetic fibers, and combinations thereof.

5. The board of claim 1, wherein the adhesive formulation covers from about 20% to about 60% of the total surface of the first paperboard.

6. The board of claim 2, wherein the adhesive formulation comprises a spacer component to control a distance between the first and second paperboards.

7. The board of claim 2, wherein the adhesive formulation covers from about 20% to about 60% of the total surface of the first paperboard.

8. The board of claim 1, wherein the first paperboard and the second paperboard are adhered together through a lamination process, and the pattern of adhesive retains its shape after the lamination process.

9. A method of producing a combined board, comprising the steps of:
providing a pattern of strands of an adhesive formulation, wherein the strands have a diameter range of about 2 points to about 20 points;
applying the pattern of adhesive to a first paperboard to provide a coated first paperboard; and
applying a second paperboard onto the coated first paperboard such that the strands are between the coated first paperboard and the second paperboard.

10. The method of claim 9, further comprising steps of applying pressure onto the board assembly and drying the board assembly.

11. The method of claim 9, further comprising a step of at least partly drying the strands prior to applying the second paperboard.

12. The method of claim 11, further comprising a step of applying a second adhesive component after at least partly drying the strands and prior to applying the second paperboard.

13. The method of claim 10, wherein after drying the board assembly, the pattern of adhesive retains its shape substantially as originally applied to the first paperboard.

14. The method of claim 9, wherein the adhesive formulation comprises an adhesive component and optionally at least one of foaming component and a filler.

15. A method of producing a combined board, comprising the steps of:
applying onto a surface of a first paperboard a layer of adhesive formulation comprising an adhesive component, a foaming component, and a filler;
placing a second paperboard onto the layer of adhesive formulation to provide a combined board assembly;
applying pressure onto the combined board assembly; and
drying the board assembly.

16. The method of claim 9, wherein the adhesive formulation covers from about 20% to about 60% of a total surface area of the first paperboard.

17. The method of claim 15, wherein the adhesive formulation covers about 20% to about 60% of a total surface area of the first paperboard.

18. The method of claim 9 wherein the adhesive formulation has a Brookfield viscosity in a range of about 2,000 cps to about 50,000 cps.

19. The method of claim 15, wherein the adhesive formulation has a Brookfield viscosity in a range of about 2,000 cps to about 50,000 cps.

20. The method of claim 9, wherein the adhesive formulation has a shear viscosity in a range from about 100 cps to about 5,000 cps.
